(19) United States
(12) Patent Application Publication
(10) Pub. No.: US 2026/0360220 A1
(43) Pub. Date: Nov. 12, 2026

(54) INDEPENDENT CONTENT CREATORS CREATING UNIQUE GAMING CONTENT

(71) Applicant: IGT, Las Vegas, NV (US)

(72) Inventors: Daniel Landry, Moncton (CA); Todd Grimm, Riverview (CA); Michael Russ, Graz (AT)

(21) Appl. No.: 19/734,930

(22) Filed: Jul. 8, 2026

Related U.S. Application Data
(62) Division of application No. 18/804,445, filed on Aug. 14, 2024.

(51) Int. Cl. G07F 17/32

(52) U.S. Cl. CPC G07F 17/326; G07F 17/3244

(57) ABSTRACT

A system includes a processor circuit and a memory coupled to the processor circuit, the memory including machine-readable instructions that, when executed by the processor circuit, cause the processor circuit to perform operations. The processor circuit is caused to provide a content creator interface to receive creative content inputs from a content creator to use in an electronic gaming machine (EGM) and to generate creative gaming content for use in the EGM and based on the creative content inputs. The processor circuit is further caused to provide a creator output that comprises the creative gaming content and that is delivered to a player via the EGM.

### CROSS-REFERENCE TO RELATED APPLICATIONS

This application is a divisional of U.S. patent application Ser. No. 18/804,445, filed on Aug. 14, 2024, entitled “INDEPENDENT CONTENT CREATORS CREATING UNIQUE GAMING CONTENT.” U.S. patent application Ser. No. 18/804,445 is assigned to the assignee of the present application.

### BACKGROUND

Embodiments described herein relate to game play features with wagering games. In slot machines such as electronic gaming machines (EGMs), the physical configuration and/or operation may be limited to originally produced designs and features. For example, game play of some features may be limited by the concepts that are designed into the EGM by machine designers. As gaming applications proliferate, there is a need to provide a wide variety of content for a wide variety of customers and customer interests that may not be limited by game designers.

### BRIEF SUMMARY

According to some embodiments, systems herein may include a processor circuit and a memory coupled to the processor circuit. The memory comprises machine-readable instructions that, when executed by the processor circuit, cause the processor circuit to perform operations. In some embodiments, the processor circuit is caused to provide a content creator interface to receive creative content inputs from a content creator to use in an electronic gaming machine (EGM) and to generate creative gaming content for use in the EGM and based on the creative content inputs. The processor circuit is further caused to provide a creator output that comprises the creative gaming content and that is delivered to a player via the EGM.

According to some embodiment, a gaming device includes a processor circuit and a memory coupled to the processor circuit. The memory includes machine-readable instructions that, when executed by the processor circuit, cause the processor circuit to receive creative content inputs that include audio elements and visual elements that are provided in a library of contents element from a content creator to use in an electronic gaming machine (EGM) and generate creative gaming content for use in the EGM and based on the creative content inputs. The processor circuit is further caused to evaluate the creative gaming content for compliance with creative content limitations. While evaluating is being performed, the processor circuit is caused to provide the EGM with the creative gaming content in a free play mode. The processor circuit is further caused to provide the creative gaming content that is approved based on an outcome of the evaluating.

According to some embodiments, a gaming device includes a display device, an input device, a processor circuit and a memory coupled to the processor circuit. Embodiments include performing operations of causing the processor circuit to provide a content creator interface to receive creative content inputs from a content creator to use in an electronic gaming machine (EGM) and that includes external creative content that is received from an external source relative to the content creator interface and the EGM. The processor circuit is further caused to evaluate the external creative content before the external creative content is provided to a user of the EGM and to generate creative gaming content for use in the EGM and based on the creative content inputs. The processor circuit is further caused to provide a creator output that includes the creative gaming content and that is delivered to a player via the EGM and receive, from the content creator, a modification to a math function of a game being played on the EGM. The processor circuit is further caused to perform compliance testing of a recalculation of the math function.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is a perspective view of a gaming device that can be configured according to some embodiments.

FIG. 2E is a perspective view of a gaming device according to further embodiments.

FIGS. 2F and 2G illustrate VR/AR devices according to various embodiments.

FIG. 3 is a schematic block diagram of system for providing independent gaming content according to some embodiments.

FIG. 4 is a flowchart illustrating operations of systems/methods of generating and providing wagering game content is illustrated, according to some embodiments.

FIG. 5 is a flowchart illustrating operations of systems/methods of generating and providing wagering game content is illustrated, according to some embodiments.

FIG. 6 is a flowchart illustrating operations of systems/methods of generating and providing wagering game content is illustrated, according to some embodiments.

### DETAILED DESCRIPTION

In some embodiments, user generated content for tokens (FTs/NFTs) may be integrated into token creation activities such as mining and/or minting. Some embodiments provide that user generated content that is non-token related may be used to earn tokens in an online system or metaverse. Some embodiments include an ecosystem and/or metaverse wherein independent content creators are able to create unique gaming content, such as for EGMs, VLTs, and/or ETGs, among others, that can be posted for play, searched, and/or ranked by players. In some embodiments, players spend tokens purchased and/or earned through play on these unique creations. In some embodiments, creators earn tokens through their content being played. Some embodiments provide that advertising revenue may be generated through a portal and shared with other creators.

Several methods for content creation can be leveraged, each with different levels of compensation. Some embodiments may include simplistic methods requiring minimal or no compliance overhead. Some other embodiments rely on open methods in which the product may be subject to a vetting process corresponding to the content, similar to application stores that require evaluation and/or compliance determination. For example, a process for ensuring that content meets certain levels of ethics and/or decency may be applied. In some embodiments, vetting may be used to determine full compliance that may include information regarding revising and/or updating the content to satisfy all requirements.

In some embodiments, resulting content may be a mixture of unusual and/or unorthodox themes and concepts that may normally not be generated together. In some embodiments provide that such mixtures may appeal to younger generations of gamblers and/or players that grew up on this type of content online. The resulting content may also be a very detailed and tailored brand experience that is polished and that may appeal to all audiences and potentially be “picked-up” and/or ported to an official online and/or land-based casino. Additionally, these creations may be assigned NFTs, allowing creators to sell, trade and/or auction off some of the more popular content in an online market. Depending on the method used for creation this may result in more valuable unique and/or limited edition NFTs and/or more generic NFTs that users are able to recreate themselves.

The disclosure herein may provide an intellectual property opportunity corresponding to this concept and/or potential related concepts by beneficially providing new online experiences and creators that may be increasingly ingrained in our collective. Examples of such ecosystems may include a Metaverse and/or an incentive to join a Metaverse.

Some embodiments include an online creation tool featuring a pool of pre-approved elements that can be combined in any way creators choose. In such embodiments, the creator may have creative experiences that may require little or no vetting and/or compliance evaluation. In some embodiments, a pool of elements may include audio elements such as theme tracks, trigger sounds, and/or win celebrations, among others. Some embodiments provide that the pool of element may include visual content such as backgrounds, symbols, and/or animations, among others. Some embodiments provide that the pool of elements includes math models such as basic game structures and/or defined mechanics, among others.

Some embodiments provide that a pool of elements can be changed, updated, and/or added to on a regular basis to keep creations fresh. Some embodiments provide that specific elements may have limited availability. For example, some pool elements may be issued only once in a limited timeframe while others may be available only periodically such as taking content out of circulation and re-issuing it with a marketing push.

In some embodiments, creators may import their own audio and/or visual elements to be used in the creative content. Some embodiments provide that a vetting operation for such elements may be necessary to prevent inappropriate content such as crude, racist, sexual and/or or otherwise inappropriate content is used. In some embodiments, a manual and/or mixed AI method may be used to vet, alter and/or update content, among others.

In some embodiments, creators may be able to influence a math model and/or volatility by being able to assign various game mechanics that make up the play experience, types of wins and/or bonuses, and/or a quantity of bonuses and/or MLP type mechanics. Such embodiments may further include a level of compliance testing and/or approval, among others.

In some embodiments, multiple components of pool elements may be added and/or structured to provide increased flexibility and/or options to experienced creators while providing a more simple approach for novice and/or recreational content creators.

Some embodiments provide that dedicated land-based casinos may have equipment such as EGMs that may have access to this type of content. In some embodiments, content and/or content elements may be selected based on being a top 10, user voted and/or a full library. In some embodiments, the content may be played with government currency and/or enjoyed in a real casino environment on a real casino cabinet.

Some embodiments provide that independent creators may create their own math models for potential use in a metaverse game. In some embodiments provide that a creator can come up with a math model, and have it vetted by a gaming company and/or an external testing agency to get it certified. Once certified, the math model may be used in a metaverse-based game that can earn an income.

Some embodiments are directed to a phased release process. For example, prior to an official release of user-created game content, such content may be available in a free play mode only. Once the game content is verified, approved and/or certified in a review, the creative content may become available for being played for money. Some embodiments provide that once the creative content is tested and/or played for free by other players, the other players may upvote the content and/or game if they like it. In some embodiments, the games with the most upvotes may be reviewed and/or certified earlier than less popular games.

In some embodiments, once a game is created by a creator it may require testing and/or verification by a given quantity of players to be released. Once a game is created it may be tested and/or verified using an AI-based game certification system that is trained to play games and auto-detect inappropriate behavior such as bad game rules, inappropriate content, and/or not-allowed math, among others. Once a game has passed the AI-certification it may become available to real players. In some embodiments, inputs and/or evaluation from a third party may be used to make a final approval decision for release.

Some game play in a metaverse may rely on numerous technologies, concepts and/or components for using and/or accessing a metaverse. Using a metaverse may include technologies to enter a metaverse, immersive technologies, such as, virtual reality, augmented reality, and/or mixed reality, among others. Other components may include traditional home entertainment technologies such as a desktop computer, a laptop computer, mobile devices and/or browser-based components, among others. Further components may include devices to create haptic sensations, such as VR gloves, VR suits, and/or VR controllers, among others. Personal settings may be used to adjust visuals, sounds, and/or notifications, among others, within their personal metaverse experience. Personal settings may be used to adjust settings with technologies such as immersive technologies and/or haptic sensation technologies, among others.

In a casino-related context, the metaverse may be a virtual place where users can play casino-like games, interact with other players, engage in social activities, and/or attend virtual concerts and/or events, among others. In some embodiments, players may be able to create avatars to represent themselves in the virtual world. Players may earn virtual currency that can be used to purchase virtual goods, trade, and/or exchange, even for real currency.

Embodiments herein may be suitable for using AR and/or VR, however, such embodiments are not so limited because traditional home use technology may be effectively used. In some embodiments, the metaverse may be able to blur the line between virtual and physical reality.

The virtual casino and other metaverse experiences can be provided through a variety of devices and technologies, such as virtual reality (VR), augmented reality (AR), personal computing devices, mobile computing devices, home entertainment technologies such as smart televisions and/or set-top boxes, among others.

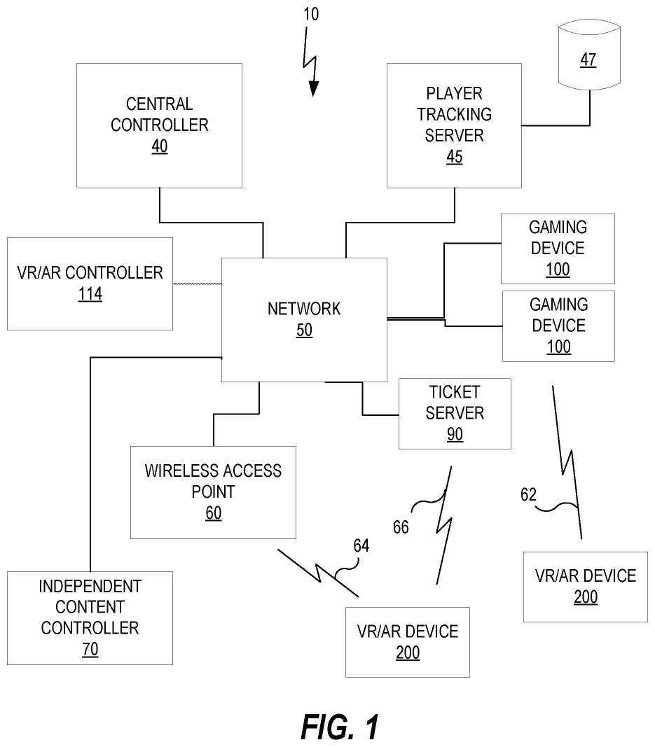

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

An independent content controller 70 may generate independent creative gaming content based on player inputs to a content creator interface. The content creator interface may receive input data that may be selected by a content creator and/or generated from a pool of elements for creating the gaming content.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

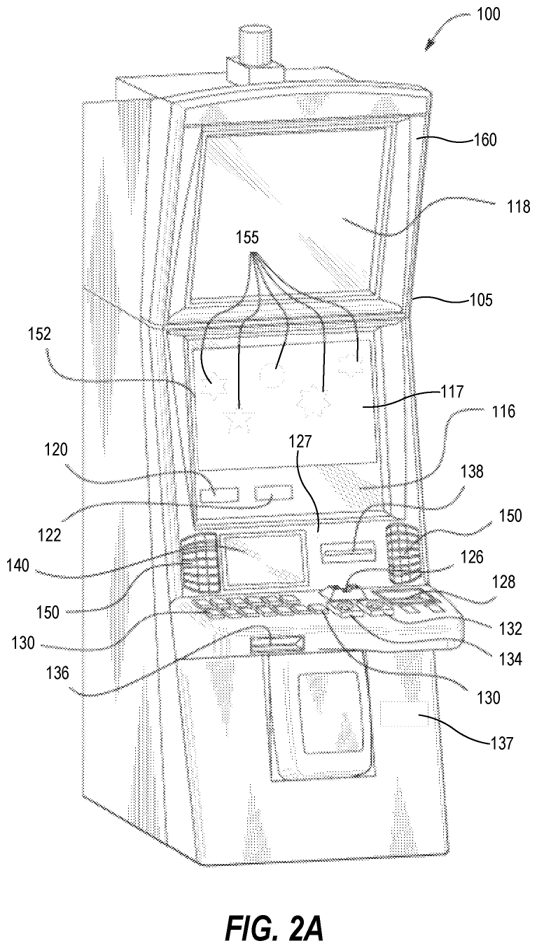

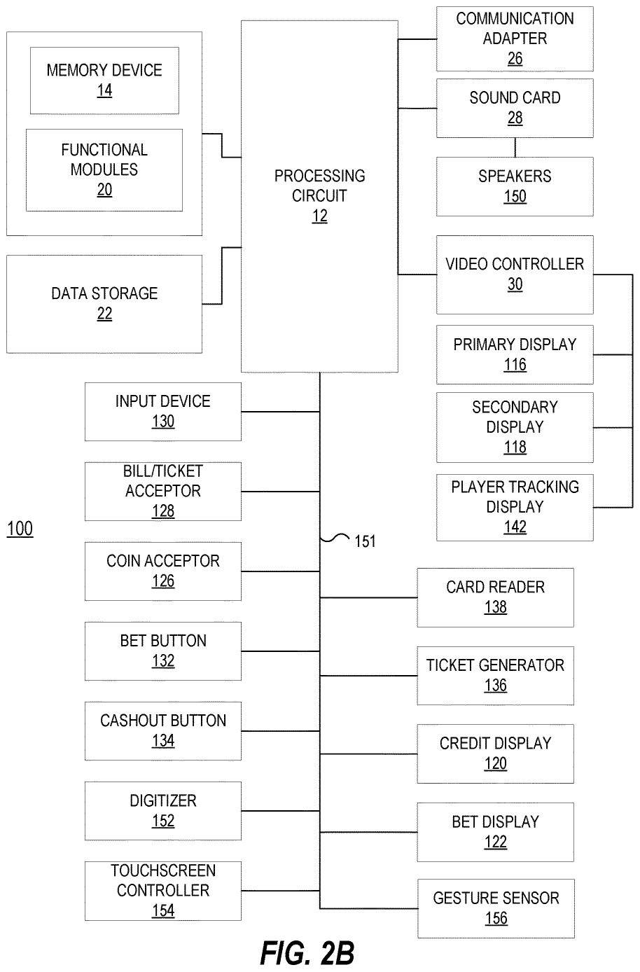

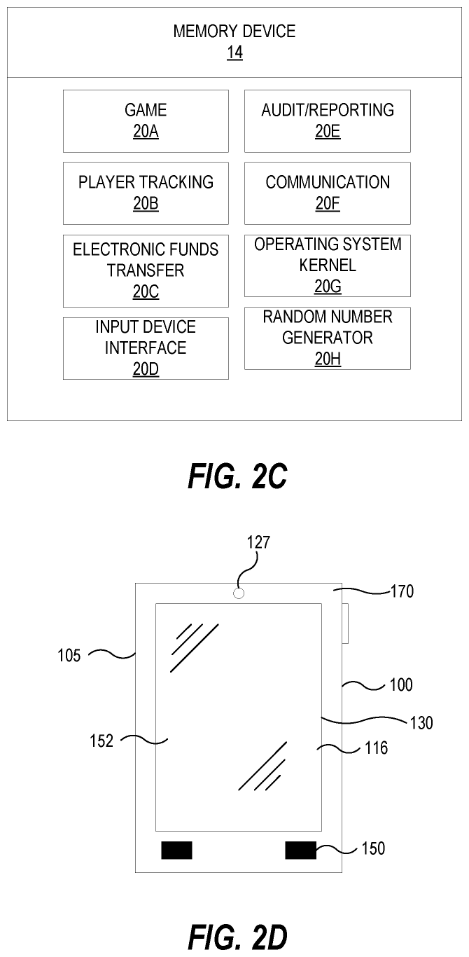

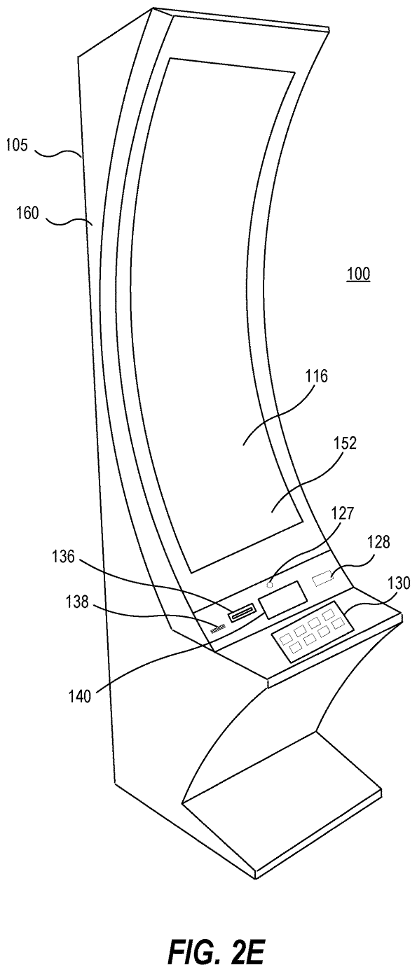

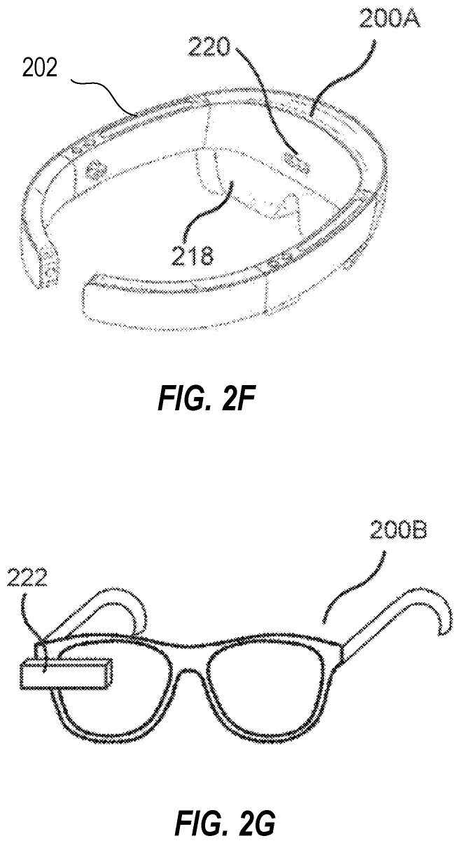

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

In some embodiments, a display provided herein may display one or more icons and/or other visual elements that include a placement of the icon and/or visual element that depends on one or more attributes of the icon and/or visual element relative to another icon and/or visual element. In this manner, the arrangement of the icons and/or visual elements may convey information based on the relative location of the icon and/or visual element and/or the visual content of the icon and/or visual element.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processor circuit through a USB hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

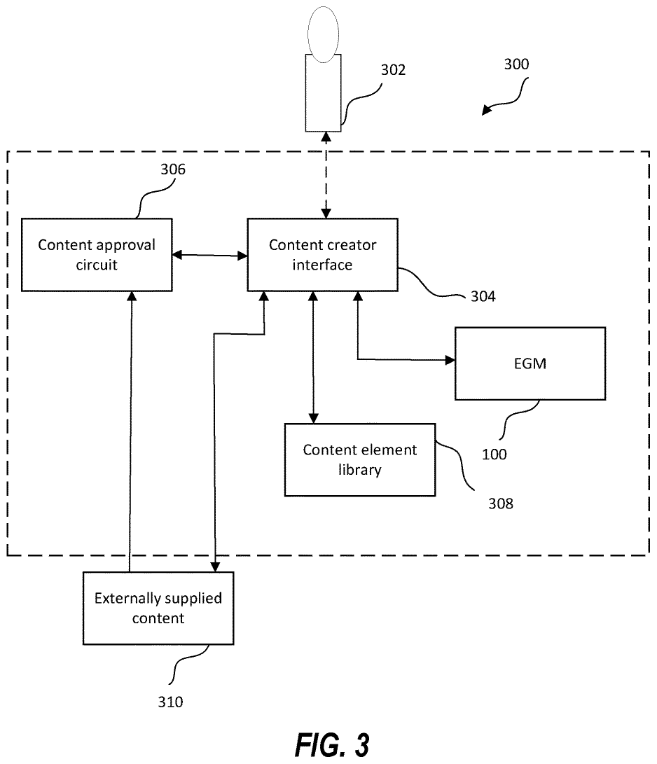

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card read-er, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

FIG. 2F illustrates a virtual reality (VR) viewer 200A implemented as a 3D headset including a pair of displays 218 on which images of virtual objects may be displayed. The viewer 200A includes a head-wearable frame 202, with the displays 218 coupled to the frame 202 to position the display device in a field of view of user wearing the viewer 200A. Different stereoscopic images may be displayed on the displays 218 to create an appearance of depth. The VR viewer 200A may include a plurality of sensors 220 that the device uses to determine a position, orientation, and/or movement of the viewer 200A, which may be used to determine a position, orientation, and/or direction of movement within an SVE.

The viewer 200A may further include other sensors, such as a gyroscopic sensor, a GPS sensor, one or more accelerometers, and/or other sensors that allow the viewer 200A to determine its position and orientation in space. In some embodiments, the viewer 200A may include one or more cameras that allow the viewer 200A to determine its position and/or orientation in space using visual simultaneous localization and mapping (VSLAM). viewer 200A may further include one or more microphones and/or speakers that allow the user to interact audially with the device.

In some embodiments, a viewer may also include semitransparent lenses that allow the user to see both the real world as well as the 3D image rendered on the lenses, e.g., to provide an augmented reality (AR) experience. The viewer may also include additional cameras or other sensors to obtain a live video signal for building a 3D model of the space around the user. The viewer may also generate a 3D image of an object to display to the user that takes into account the real-world objects around the user and allows the user to interact with the 3D object.

Referring to FIG. 2G, an augmented reality (AR) viewer 200B may be implemented as a pair of glasses including a transparent prismatic display 222 that displays an image to a single eye of the user. Such a device may be capable of displaying images to the user while allowing the user to see the world around the user, and as such can be used as an AR device.

In other embodiments, a VR and/or AR viewer may be implemented using a virtual retinal display device that raster scans an image directly onto the retina of the user. In still further embodiments, a VR and/or AR viewer may be implemented using a mobile wireless device, such as the mobile gaming device 170 of FIG. 2D above, a mobile telephone, a tablet computing device, and/or a personal digital assistant, etc.

Although illustrated as certain gaming devices, such as electronic gaming machines (EGMs), mobile gaming devices, VR/AR headsets, etc., functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Reference is now made FIG. 3, which is a schematic block diagram of system for providing independent gaming content according to some embodiments. Some embodiments include a content creator interface 304 that may provide access for a creator 302 to system components, system operations, elements and/or pools of content creator elements. For example, the content creator interface 304 may evaluate content creator elements that may be provided in a content element library 308. Some embodiments provide that content creator elements in the content element library 308 may be analyzed prior to availability for appropriateness and/or approval for use. In some embodiments, the content creator interface 304 may select and/or receive creative content from externally supplied content 310. In such embodiments, a content approval circuit 306 may analyze externally supplied content 310 to determine if such content meets content and/or performance requirements.

Once created content is approved, such content may be transmitted to an EGM 100 or other type of equipment. Although illustrated as different components, some embodiments provide that one or more functions and/or structures may be included in a single structure.

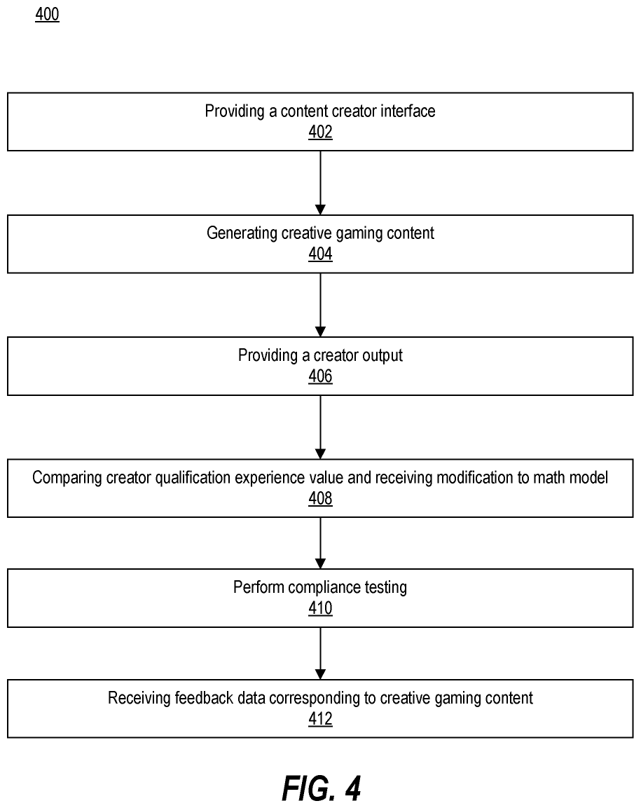

Reference is now made to FIG. 4, which is a flowchart illustrating operations of systems/methods of generating and providing wagering game content is illustrated, according to some embodiments. Systems herein may include a processor circuit and a memory coupled to the processor circuit. The memory comprises machine-readable instructions that, when executed by the processor circuit, cause the processor circuit to perform operations. In some embodiments, the processor circuit is caused to provide (block 402) a content creator interface to receive creative content inputs from a content creator to use in an electronic gaming machine (EGM). In some embodiments, the creative content inputs include multiple content elements and multiple types of content element types. Some embodiments provide that the content element types include an audio element type and/or a video element type, among others.

In some embodiments, the creative content inputs include multiple thematically related elements including a first content element type and a second content element type that is different from the first content element type.

Some embodiments provide that the creative content inputs include multiple content elements that are automatically changeable from a first control element to a second content element based on events that are external to the content creator interface.

In some embodiments, the creative content inputs include multiple content elements that are automatically updated from a first version of a control element to a second version of the control element based on receiving additional creative content inputs that correspond to the control element.

Some embodiments provide that the creative content inputs are received from a content element library that includes multiple creative content inputs that are previously evaluated and approved for use by the content creator.

In some embodiments, the creative content inputs include external creative content that is received from an external source relative to the content creator interface and the EGM.

In some embodiments, operations include evaluating the external creative content before the external creative content is provided to a user of the EGM. Some embodiments provide that the creative gaming content includes a replacement content that replaces a portion of previous gaming content.

In some embodiments, the creative content inputs include a recalculation of a math function of the EGM. In some embodiments, the math function includes data that corresponds to a payout of a game being played on the EGM.

Some embodiments include generating (block 404) creative gaming content for use in the EGM and based on the creative content inputs.

Some embodiments provide that the recalculation of the math function of the EGM includes a previously defined range of acceptable changes to the creative gaming content. In some embodiments, the recalculation of the math function of the EGM includes a change of types of wins and bonuses. Some embodiments provide that the recalculation of the math function of the EGM includes a change in volatility of the game being played on the EGM.

Operations may include providing (block 406) a creator output that includes the creative gaming content and that is delivered to a player via the EGM.

In some embodiments, the content creator interface includes a creator qualification experience value that defines an experience level of the content creator. Some embodiments provide that which of multiple creative content inputs are available to the content creator is determined based on the creator qualification experience value.

Embodiments further include comparing (block 408) the creator qualification experience value to a threshold qualification experience value. In response to the creator qualification experience value being greater than the threshold qualification experience value, the processor circuit is further caused to receive, from the content creator, a modification to a math model of a game being played on the EGM.

Some embodiments provide that the creative content inputs include a recalculation of a math function of the EGM, wherein the processor circuit is further caused to perform (block 410) compliance testing of the recalculation of the math function. In some embodiments, while the math function is being tested, plays of a game on the EGM are limited to freeplay.

Some embodiments provide that, while the math function is being tested, the processor circuit is caused to receive (block 412) feedback data corresponding to the creative gaming content from multiple players while playing in freeplay.

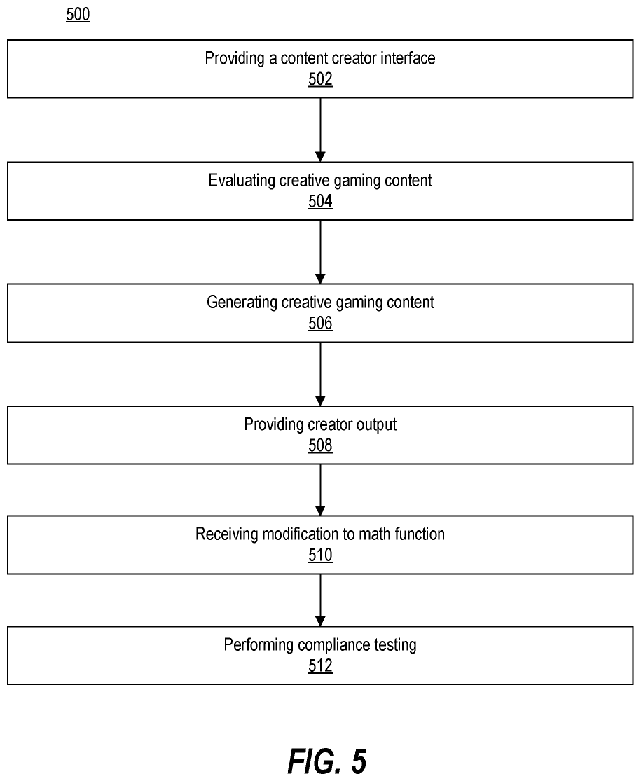

Reference is now made to FIG. 5, which is a flowchart illustrating operations of systems/methods of generating and providing wagering game content is illustrated, according to some embodiments. Methods according to some embodiments include operations of providing (block 502) a content creator interface to receive creative content inputs from a content creator to use in an electronic gaming machine (EGM) and that includes external creative content that is received from an external source relative to the content creator interface and the EGM. Operations include evaluating (block 504) the external creative content before the external creative content is provided to a user of the EGM and generating (block 506) creative gaming content for use in the EGM and based on the creative content inputs. Operations include providing (block 508) a creator output that includes the creative gaming content and that is delivered to a player via the EGM and receiving (block 510), from the content creator, a modification to a math function of a game being played on the EGM. Operations include performing (block 512) compliance testing of a recalculation of the math function.

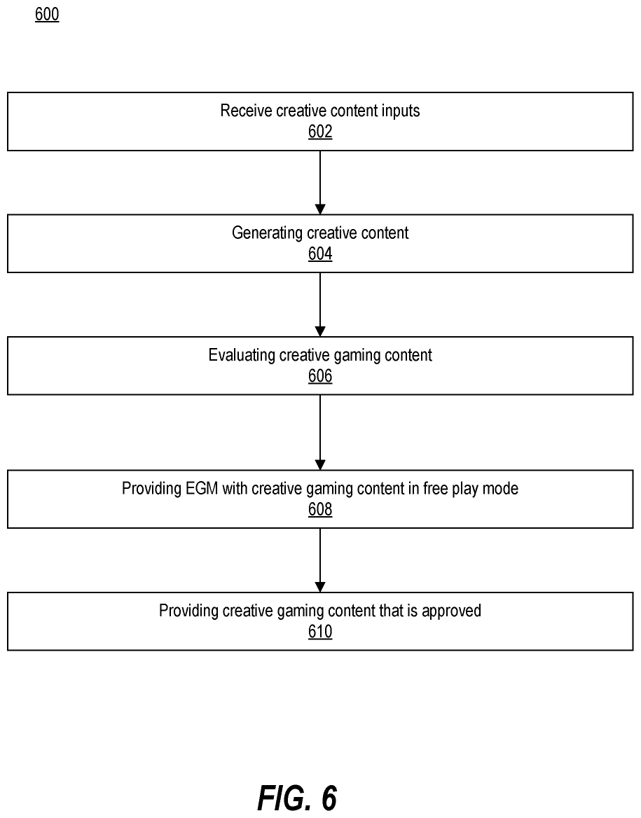

Reference is now made to FIG. 6, which is a flowchart illustrating operations of systems/methods of generating and providing wagering game content is illustrated, according to some embodiments. A gaming device includes a processor circuit and a memory coupled to the processor circuit. The memory includes machine-readable instructions that, when executed by the processor circuit, cause the processor circuit to receive creative content inputs that include audio elements and visual elements that are provided in a library of contents element from a content creator to use in an electronic gaming machine (EGM) and generate creative gaming content for use in the EGM and based on the creative content inputs. The processor circuit is further caused to evaluate the creative gaming content for compliance with creative content limitations. The processor circuit is further caused to provide the EGM with the creative gaming content in a free play mode while the evaluation is being performed. The processor circuit is further caused to provide the creative gaming content that is approved based on an outcome of the evaluation.

Some embodiments provide that the modification to the virtual environment includes a modification to change a characteristic of the virtual EGM in the virtual environment. In some embodiments, the virtual EGM includes a virtual slot machine and the characteristic corresponds to a quantity of reels in the virtual slot machine. In some embodiments, the characteristic includes a selectable quantity of reels. Some embodiments provide that a limit on wager content is based on the reels in the virtual slot machine. Ins some embodiments, the virtual EGM includes a virtual slot machine. Some embodiments provide that the virtual EGM includes the characteristic corresponding to a reel height in the virtual slot machine and the characteristic includes a selectable reel height. Some embodiments provide that there is a limit on wager content that is based on the reel height in the virtual slot machine.

In some embodiments, the user includes a user avatar in the metaverse that corresponds to the user. Some embodiments provide that the virtual EGM includes a skill-based game, and the metaverse includes a spectator avatar corresponding to another user that is watching the user's performance on the virtual EGM. In some embodiments, the processor circuit is caused to receive a wager from the spectator avatar based on the user's performance in the virtual EGM.

Some embodiments provide that, in response to the user triggering a given bonus, the processor circuit is caused to transfer the user within the metaverse to the virtual environment that corresponds to the given bonus. In some embodiments, the processor circuit is caused to merge content of multiple virtual EGMs into a single EGM.

In some embodiments, a gaming device may be operated by a mobile device, such as a mobile telephone, tablet and/or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor circuit of a general purpose computer, special purpose computer, or other programmable data processing apparatus to produce a machine, such that the instructions, which execute via the processor circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
receive creative content inputs that include audio elements and visual elements that are provided in a library of contents element from a content creator to use in an electronic gaming machine (EGM);
generate creative gaming content for use in the EGM and based on the creative content inputs;
evaluating the creative gaming content for compliance with creative content limitations;
while evaluating is being performed, provide the EGM with the creative gaming content in a free play mode; and
provide the creative gaming content that is approved based on an outcome of the evaluating.

2. The system of claim 1, wherein the evaluating comprises ensuring that the creative gaming content meets certain levels of ethics.

3. The system of claim 1, wherein the evaluating comprises ensuring that the creative gaming content meets certain levels of decency.

4. The system of claim 1, wherein the processor circuit is further configured to:
based on the evaluating, revise the creative gaming content.

5. The system of claim 1, wherein the creative content inputs comprise a plurality of content elements that are automatically updated from a first version of a control element to a second version of the control element based on receiving additional creative content inputs that correspond to the control element.

6. The system of claim 1, wherein the creative content inputs are received from a content element library that comprises a plurality of creative content inputs that are previously evaluated and approved for use by the content creator.

7. The system of claim 1, wherein the processor circuit is further configured to:
transmit the approved creative gaming content to the EGM.

8. The system of claim 1, wherein the creative gaming content comprises a plurality of backgrounds.

9. The system of claim 1, wherein the creative gaming content comprises a plurality of symbols.

10. The system of claim 1, wherein the creative gaming content comprises a plurality of animations.

11. A method comprising:
receiving creative content inputs that include audio elements and visual elements that are provided in a library of contents element from a content creator to use in an electronic gaming machine (EGM);
generating creative gaming content for use in the EGM and based on the creative content inputs;
evaluating the creative gaming content for compliance with creative content limitations;
while evaluating is being performed, provide the EGM with the creative gaming content in a free play mode; and
providing the creative gaming content that is approved based on an outcome of the evaluating.

12. The method of claim 11, wherein the evaluating comprises ensuring that the creative gaming content meets certain levels of ethics.

13. The method of claim 11, wherein the evaluating comprises ensuring that the creative gaming content meets certain levels of decency.

14. The method of claim 11, further comprising based on the evaluating, revising the creative gaming content.

15. The method of claim 11, wherein the creative content inputs comprise a plurality of content elements that are automatically updated from a first version of a control element to a second version of the control element based on receiving additional creative content inputs that correspond to the control element.

16. The method of claim 11, wherein the creative content inputs are received from a content element library that comprises a plurality of creative content inputs that are previously evaluated and approved for use by the content creator.

17. The method of claim 11, further comprising:
transmitting the approved creative gaming content to the EGM.

18. The method of claim 11, wherein the creative gaming content comprises a plurality of backgrounds.

19. The method of claim 11, wherein the creative gaming content comprises a plurality of symbols.

20. A gaming device comprising:
a processor circuit; and
a memory coupled to the processor circuit, the memory comprising machine-readable instructions that, when executed by the processor circuit, cause the processor circuit to:
receive creative content inputs that include audio elements and visual elements that are provided in a library of contents element from a content creator to use in an electronic gaming machine (EGM);
generate creative gaming content for use in the EGM and based on the creative content inputs;
evaluating the creative gaming content for compliance with creative content limitations;
while evaluating is being performed, provide the EGM with the creative gaming content in a free play mode; and
provide the creative gaming content that is approved based on an outcome of the evaluating.
